(19) United States
(12) Patent Application Publication
(10) Pub. No.: US 2007/0169035 A1
(43) Pub. Date: Jul. 19, 2007

(54) Method and system for configuring the language of a computer program

(75) Inventor: Thomas Seidenbecher, Erlangen (DE)

Correspondence Address: LERNER GREENBERG STEMER LLP, P O BOX 2480, HOLLYWOOD, FL, 33022-2480, US

(73) Assignee: Siemens AG

(21) Appl. No.: 10/574,064

(22) PCT Filed: Sep. 30, 2003
(86) PCT No.: PCT/DE03/03310

§ 371 Date: Mar. 30, 2006

(51) Int. Cl. G06F 9/45

(52) U.S. Cl. 717/141

(57) ABSTRACT

A method and a system for configuring the language of a computer program. The method steps include: selection of a text memory wherein alphanumeric message character strings are assigned to alphanumeric identification expressions; detection of identification expressions in the text memory belonging to wildcard character strings that are contained in the computer program, and replacement of the wildcard character strings of the computer programme with the message character strings assigned in the text memory. The detection and replacement process is carried out during the run time of the executable binary computer program. To carry out the replacement, the message character strings are assigned to memory variables of the active computer program.

The invention relates to a method in accordance with the precharacterizing part of patent claim 1 and to a system in accordance with the precharacterizing part of patent claim 7.

If a computer program is to be used in various countries or regions with a respective different language then it is frequently desirable to match the graphical display of the computer program and particularly the dialogs of the user interface for the program to the respective language of the country or region. In this case, the display of a starting language e.g. set as standard—for example German—is changed to a preferred selection language—for example English.

This operation of matching the language of a computer program to various other languages, usually called “localization” on the basis of the prior art, is assisted, on the basis of the prior art, by virtue of the computer program already being designed for simple localizability at the design stage. This form of program design is called “Internationalization” on the basis of the prior art.

Existing approaches to internationalization firstly provide for wildcard expressions to be provided in the source text of the computer program instead of the texts which are to be used for the dialogs in the computer program, such as menus, buttons or texts for direct help. These wildcard expressions are then used in all parts of the computer program instead of the relevant message texts, that is to say those parts which are displayed to the user of the computer program. In particular parts of the source text of the computer program, for example in “header files”, compiler definitions are then created, for example “# define” expressions, in which the wildcards are attributed the desired message texts in a particular national language. While the computer program source text is being compiled, the compiler then first of all replaces every wildcard which occurs in the source text with the message text in line with the compiler definition from the relevant part of the computer source text.

The effect achieved by this is that localizing to a particular national language requires only the relevant compiler definitions to be replaced, which are then replaced in the source text by the compiler during the compiling process.

However, this method has the practical drawback that localizing the computer program requires said method to be in the computer program's source text. This is a drawback particularly when localization matching operations are to be performed in the branch in the respective target country, for example, or specific matching operations are to be performed for a customer in situ, for example. In these cases, it is frequently not desirable to pass on the entire source text of the program. In addition, this method requires an appropriate development environment for compiling the program, which gives rise to additional complexity of engineering, time and cost.

On the other hand, it is known practice on the basis of the prior art to precompile a program in modular fashion such that all language-specific parts of a program are arranged in separate parts of the binary computer program, known as dynamic link libraries (DLLs). In this case, entry addresses are provided between the individual DLLS, so that the relevant parts of the binary—that is to say already compiled and executable—computer program are assembled in a well defined manner. It is thus possible for a first part of the binary computer program to call the country-specific message text at a particular entry address for a country-specific DLL.

Although this method no longer requires the entire source text to be present for localizing the computer program, it is nevertheless necessary to disclose the country-specific parts of the source text which are intended to have the language matching performed for them, and in this case too the localization requires the presence of an appropriate development environment together with a compiler in order to create a DLL from the localized source text parts.

This is an obstacle particularly for when small changes are made retrospectively for a customer or by the customer himself.

It is an object of the present invention to specify a method and a system for configuring the language of a computer program which avoid the drawbacks discussed above and allow retrospective matching of the language of an executable computer program in binary form, particularly with little complexity.

This object is achieved by a method in accordance with patent claim 1 and by a computer system in accordance with patent claim 7.

The effect achieved by finding identification expressions in a text memory which are associated with wildcard character strings contained in the computer program and replacing the wildcard character strings in the computer program with the associated message character strings in the text memory during the runtime of the executable binary computer program is that language configuration or localization, i.e. matching the wording of the message character strings, requires no manual or automated action to be taken in the source text of the computer program. This allows localization or retrospective matching to be performed without recompiling and hence without the development environment which is required for recompiling.

This also allows language matching to be performed during continuous use of the computer program too, i.e. without stopping or terminating the running computer program.

The fact that said replacement of the wildcard character strings in the computer program with associated message character strings in the text memory is effected by attributing the message character strings to memory variables in the running computer program means that it becomes possible to leave the binary computer program unchanged during localization matching, while only dynamic contents of the store associated with the computer program change during said replacement operations. Particularly in contrast to the storage of static character string constants, this is done at stipulated entry addresses, as are used when using dynamic link libraries (DLLs).

The effect achieved by the interaction of these features is that the computer program does not need to have its executable binary code changed in order to perform language matching.

These advantages are achieved in appropriate fashion in the inventive computer system by virtue of the computer program being in executable binary code, and means for finding identification expressions in a text memory which are associated with wildcard character strings contained in the computer program and for replacing the wildcard character strings in the computer program with the associated message character strings in the text memory being contained in the computer program.

Another advantageous effect which this achieves is that it avoids a specific software tool for creating and compiling the points in the source text of the computer program which relate to the language display being introduced into the system in addition to the computer program and hence giving rise to an increase in complexity. This also significantly simplifies the incorporation of the program code used for finding items in the text memory and replacing items in the computer program's store into the computer program which is to be localized.

Advantageous developments of the invention are possible in the subclaims referring back to claim 1 and to claim 7 and are explained briefly below:

If the method is advantageously developed such that the text memory is selected so that the identification expressions contain alphanumeric name descriptors and alphanumeric field descriptors and that a respective field descriptor has an associated message character string, then it becomes possible to combine a plurality of pairs of values, each comprising an alphanumeric field descriptor and a message character string, to produce a superordinate data structure which is identified by means of the name descriptor and to address them as a group using said alphanumeric name descriptors. In this way, all the message character strings associated with a dialog, for example for buttons in a dialog and for pop-up context message texts, can be addressed as a group using the common name descriptor in a single, common reference by a suitable wildcard character string in the computer program.

If the method is advantageously developed such that an identification expression in the text memory is found for a wildcard character string contained in the computer program by evaluating a path for the wildcard character string, which path is formed from at least one of said name descriptors, then it becomes possible to address a specific name descriptor in a logically consistent manner when a plurality of name descriptors are nested in one another. Such hierarchically nested name descriptors make it possible, by way of example, to set up local validity areas for name descriptors, which improves the extendability of the system and reduces the susceptibility to errors during localization.

In this case, in line with the order of the name descriptors of the path, the nested name descriptors in the text memory are addressed until there are no further name descriptors along the path and the pairs of values can be clearly determined and read from the field descriptor and the message character string.

The use of a path comprising alphanumeric name descriptors as a wildcard character string in the computer program is particularly advantageous because such a character string, according to the type of data structure, is similar to the replacing message character string and can therefore be easily processed during the replacement operation.

If the method is developed such that the XML format is selected for the design of the text memory, and the identification expressions are found by interpreting XML tags, then a popular, cross-platform data format is chosen which can be handled by a large number of editors and which has a syntax which can easily be checked for errors and inconsistencies to a large extent using popular methods.

The XML language definition referred to here and in the whole of the present description, and conceptualities in this regard, are disclosed in Bray et. al.: “Extensible Markup Language (XML) 1.0 (Second Edition), W3C Recommendation, Oct. 6, 2000. The XML tags are used to find a form for the alphanumeric identification expressions which is suitable for the XML format.

If the XML text memory, for example an XML file, is selected such that it is structured in the form of an XML table then an XML-suitable form is specified in which the nested name descriptors which have been selected for storage are the relevant XML tags forming an XML table.

If the method is advantageously developed such that the wildcard expressions to be replaced are respectively read from a memory variable in a dialog structure in the computer program, then it is a particularly simple matter to use software which exists during program design and implementation to create dialogs for the user interface of a computer program without needing to make any changes to this existing software. In this way, the dialog can be created, for example using a graphical dialog editor, in a conventional fashion and the wildcard character string can be input instead of the dialog text which normally needs to be input.

The computer system can advantageously be produced in line with the above developments of the method.

The features of all the claims can advantageously be combined in any manner within the context of the invention.

In line with the advantageous embodiment of the text memory in XML format, the name descriptors used in the advantageously developed computer system for language configuration, too, may be shown as XML tag names and field descriptors may be shown as XML attribute names. Accordingly, the message character strings in the text memory of this type are shown as XML attribute values. The terms XML tag name, XML attribute name and XML attribute value are accordingly defined as tag name, attribute name and attribute value in said W3C recommendation dated Oct. 6, 2000.

The method and the system can be developed such that the wildcard character string, which may advantageously be stored in a memory variable in a dialog structure in the computer program, starts with a characteristic prefix, preferably comprising alphanumeric symbols. As a result, such character strings stored in a dialog structure, which are wildcard character strings, can easily be distinguished from character strings which are not to be localized in dialogs in the user interface of the computer program.

The invention is explained below with reference to an exemplary embodiment, a source text listing and a few figures, in which:

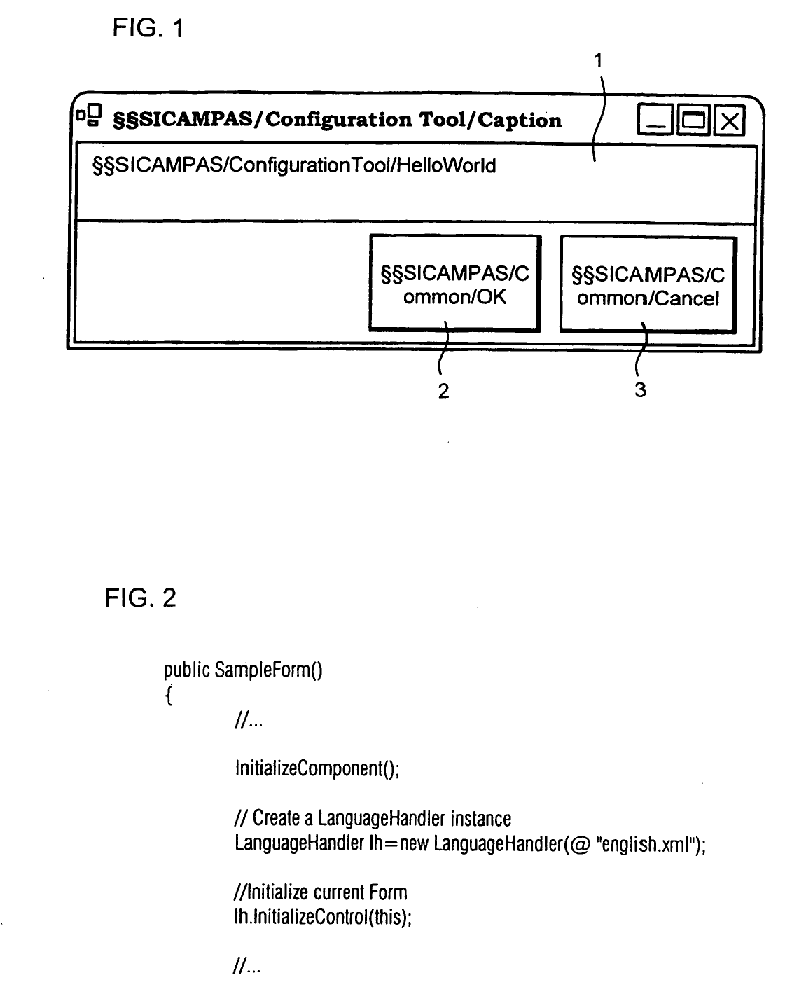

FIG. 1 shows the schematic illustration of a dialog box with three dialog elements, each containing a wildcard character string as dialog text,

FIG. 2 shows a code fragment as an example of the use of the method implemented in a language handler object,

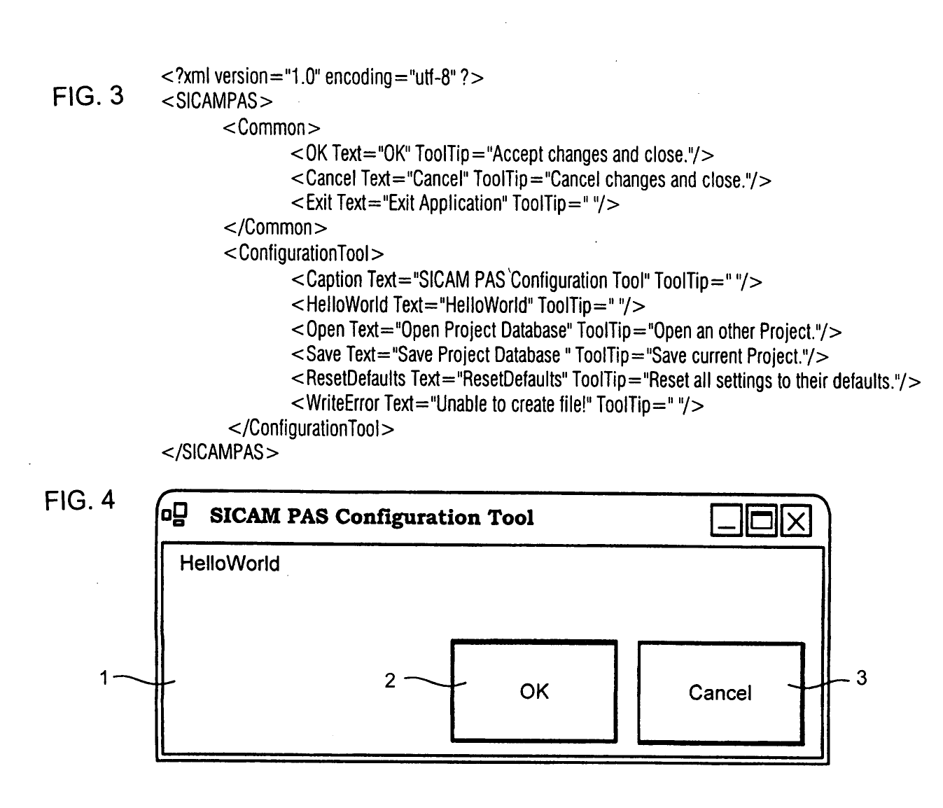

FIG. 3 shows a text memory, in the form of an XML file, with entries in the form of an XML table,

FIG. 4 shows the dialog shown in FIG. 1 after the replacement method has been carried out for this dialog, and

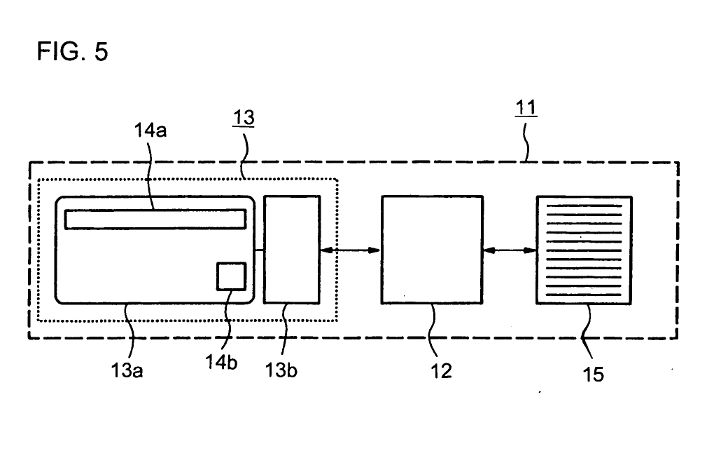

FIG. 5 shows a schematic illustration of a computer system for carrying out language matching for the display of a computer program.

FIG. 1 shows a dialog box in a user interface of a computer program with a text field 1, a first button 2 and a second button 3. This dialog box may have been created, by way of example, using ordinary program libraries for creating graphical user interfaces (GUI libraries), for example by programming or by using a development tool for a computer-aided development of user interfaces. The text usually contained in the popular graphical elements, in this figure the text which is contained in the text field 1, in the first button 2 and in the second button 3, has usually been attributed as a character string parameter (for example “string”), as in the aforementioned development methods for user interfaces.

In this example, these character strings are in the form of wildcard character strings which start with a characteristic prefix, for example two successive paragraph characters. In this way, wildcard character strings can easily be distinguished from dialog texts, which are not wildcard character strings, in the subsequent method.

For the rest, the wildcard character strings are constructed from name descriptors in the form of XML tag names, in the present case “SICAMPAS”, “ConfigurationTool” and “HelloWorld”, for example, in text field one, and “SICAMPAS”, “Common” and “OK”, for example, in the first button 2. These are separated from one another by oblique strokes. This produces a path comprising XML tags or name descriptors, which allow the nested name descriptors to be resolved in the subsequent method, or allow the desired entry to be found in an XML table.

Accordingly, the text character strings for the buttons 2 and 3 are constructed from a characteristic prefix, XML tags as name descriptors and separating oblique strokes to produce wildcard character strings which, minus the characteristic prefix, produce an XML path.

FIG. 2 shows a C-Sharp code fragment which might be associated with a dialog box in FIG. 1 by way of example. This produces an instance of a language handler object and transfers to it the name of an XML file “english.xml” as a parameter. This XML file is a text memory within the context of the invention, the design of which is described by way of example below in FIG. 3.

Following initialization of the dialog element shown by way of example in FIG. 1 by the instructions “InitializeComponent”, an object from the class LanguageHandler is produced, as explained above, which for its part uses the aforementioned XML file as a text memory.

To prompt the actual localization process, that is to say the replacement of the wildcard character strings shown in the dialog elements 1, 2 and 3 in FIG. 1 with the desired message character strings, the method “InitializeControl” from the aforementioned language handler object is called in the present code fragment in FIG. 2. However, this function call can also be made by any other programming methods which are usual in the field.

Having been initiated by this function call, each dialog element 1, 2 and 3 in FIG. 1 is now successively visited during the further program/method execution, a check is performed to determine whether the character string which is present in the respective dialog element is a wildcard character string by looking for the characteristic prefix (“§§”), and then the characteristic prefix is removed from the respective wildcard character string and the remaining XML path is used to read the entry addressed by this path in the XML file, which has already been opened during production of the language handler object. After that, the value associated with the entry, namely the message character string, is substituted for the character string originally contained in the respective dialog element, i.e. the wildcard character string stored in the respective dialog element is replaced with the relevant message character string which has been ascertained. Within this context, it is possible for a single path stored as a wildcard character string in the respective dialog element to replace a plurality of associated character string values, too, for example ToolTip texts (explanatory texts which pop up on the basis of the position of a mouse pointer on the display panel) associated with the dialog elements 1, 2 and 3, or status bar texts.

FIG. 3 shows an exemplary embodiment of the design of the text memory in XML format. Name descriptors contained in an identification expression are in this case in the form of XML tags which are each enclosed by angled brackets. Field descriptors contained in identification expressions in the text memory are in this case in the form of XML attribute names, which are situated on the left-hand side of an equals sign. On the right-hand side of the equals sign, enclosed by quotation marks, the replacing message character strings are stored, as XML attribute values. In this context, attribute names and attribute values form pairs of values in the XML text memory.

The first button 2 in FIG. 1 is used to describe the ascertainment of the message character strings associated with wildcard character strings contained in the computer program. As already outlined, the character string originally stored in the dialog element is adjusted for the characteristic prefix, and the remaining part is interpreted as a path comprising XML tags in order to localize the relevant entry in the text memory. In this case, said path represents the key criterion which is used to interpret the characters contained in the XML text memory, so that the entry being sought can be localized. These characters contained in the text memory in the syntax or in the format of the text memory form the respective identification expression associated with the path, which expression contains not only special characters but also tag names and attribute names. The path “SICAMPAS/Common/OK”, considered to be an XML path, thus results in the identification expression being found, which is constructed from the nested XML tags <SICAMPAS>, <Common> and <OK Text=ToolTip=/>.

When this entry has been distinctly localized in this way, the message character string (“OK”) associated with the XML attribute name is substituted for the wildcard character string. This replacement is made by attributing it to the memory variable under which the wildcard character string was previously stored. Accordingly, the wildcard attribute value associated with the attribute name “ToolTip” is attributed to the relevant memory variable for the dialog structure. To this end, this memory variable does not need to have been filled with a particular value beforehand. FIG. 4 shows, by way of example, the result of the completed replacement method for the dialog elements shown in FIG. 1 using wildcard character strings. The wildcard character strings contained in the dialog elements 1, 2 and 3 in FIG. 1 have been replaced in the manner described above, using the text memory shown in FIG. 3, with the associated message character strings in said text memory, and now form the textual content of the dialog elements 1, 2 and 3 in FIG. 4. ToolTip texts are not shown in more detail in this figure.

In this way, a simple change to the content of an XML file which is shown in FIG. 3 can be matched to the textual contents of dialog elements in the user interface of a computer program, for example as part of localization to the target language of a country or of a region, without any change needing to be made to the binary code of the executable computer program. In addition, the use of XML paths specifies a method for addressing entries in the text memory which is easy for people to understand and which allows people to find entries easily, particularly when nested name descriptors are being used, without this requiring the entire document to be searched line by line.

The fact that no further association tables, such as tables with associations between numerical IDs and associated character strings, or wildcards are required reduces the complexity of maintenance and achieves better clarity. In addition, only a single resource exists for a dialog in the user interface, which means that synchronization of the resources in various languages among one another is dispensed with.

Finally, FIG. 5 shows a computer system 11 in a type of block diagram by way of example. The computer system 11 in this context may be any electrical appliance whose functions are performed at least partly under the control of a microprocessor 12, for example a personal computer, mobile telephones, consumer electronics appliances or else automation appliances in automated processes, e.g. protective devices and controllers in power supply and distribution systems. Such an appliance normally has a display apparatus 13, e.g. a monitor or a display. The display apparatus 13 has a display panel 13a, for example the screen surface of a monitor, and a display control 13b, e.g. with control programs such as drivers for producing a display on the display panel 13a and display memories for buffer-storing elements of the display. By way of example, the display panel shows display objects 14a and 14b, which have texts (not shown in FIG. 5) in a starting language which is displayed first of all.

To change the language displayed from the starting language to a preferred selection language, a command from a computer program executed by the microprocessor 12 is used during operation of the computer system to examine memory areas in the computer system which are associated with the display objects 14a and 14b—e.g. the display memories of the display control 13b—for wild card characteristics, e.g. paths comprising XML tags, under microprocessor control. These are replaced in identification expressions and transferred to a text memory chip 15 in line with the procedure explained further above under the control of the microprocessor 12. This text memory chip 15 contains, in a text memory, e.g. an XML table, message character strings in the selection language which are associated with these identification expressions. Upon request by the microprocessor 12, message character strings associated with corresponding identification expressions are ascertained and are transferred to the microprocessor 12 and then to the display memory of the display control 13b. Finally, the message character strings in the (newly selected) selection language are inserted into the display objects at the positions prescribed by the wildcard character strings instead of the previous character strings in the starting language. The display objects 14a and 14b are then displayed in the preferred selection language.

In summary, the computer system 11 shown in FIG. 5 is thus, in the general sense, an electrical appliance with at least one microprocessor 12 and a display apparatus 13 on which at least one display object 14a, 14b is shown in a starting language. A selectable text memory chip 15 is provided which contains alphanumeric message character strings in the selection language which are associated with alphanumeric identification expressions. To change from the starting language to the selection language which is to be displayed from now on, this chip outputs message character strings in the selection language which are associated with selected identification expressions, upon request by the microprocessor 12, when an identification expression is applied to it which corresponds to a wildcard character string associated with the at least one display object 14a, 14b.

In practical operation, it is possible to reconfigure a program or a computer system to a language other than the one currently being used by simply replacing a file contained in the text memory, for example by simply copying over this file. Using the code fragment shown in FIG. 2, this could be achieved by replacing the file english.xml with an altered or completely different file called english.xml, for example. This allows spelling mistakes and grammatical errors, for example, in the original xml file to be corrected in situ on the customer's premises too, since it is not necessary to regenerate software. The listing below gives a detailed description of an implementation based on the method in a computer system in the language C-Sharp:

using System:
using System.Xml;
using System.Xml.XPath;
using System.Windows.Forms;
using System.IO;
namespace Siemens.PTD.Sicam.PAS.LanguageHandler
{

/// <summary>

/// This class contains all required operations for
the language handling
/// </summary>
public class LanguageHandler
{

#region Protected Members

protected XmlDocument m_Doc;

#end region
#region Construction / Dispose

/// <summary>
/// Constructs a ResourceManager object.
/// </summary>
/// <param name=“languageFilePath”>Path to language
table</param>
public LanguageHandler (string languageFilePath)
{

m_Doc = new XmlDocument( ) ;
m_Doc.Load(languageFilePath) ;

}
#endregion
#region Public Methods
/// <summary>
/// Initializes the language of a Control and its
context menu.
/// </summary>
/// <param name=“ctrl”>Control to be initialized</param>
public void InitializeControl(Control Ctrl)
{

if (ctrl == null)

return;

HandleControlLanguage(ctrl) ;
InitializeControl(ctrl.ContextMenu)

}
/// <summary>
/// Initializes the language of a Menu and all its
items.
/// </summary>
/// <param name=“ctrl”>Menu to be initialized</param>
public void InitializeControl(Menu mnu)
{

if (mnu == null)

return;

foreach (MenuItem item in mnu.MenuItems)
{

HandleMenuLanguage(item) ;

}

/// <summary>
/// Initializes the language of a Form and its menu.
/// </summary>
/// <param name=“ctrl”>Menu to be initialized</param>
public void InitializeControl(Form Ctrl)
{

if (ctrl == null)

return;

InitializeControl((Control)ctrl) ;
InitializeControl(ctrl.Menu) ;

}
/// <summary>
/// Gets a single Text from the language table
/// </summary>
/// <param name=“textPath”></param>
/// <returns></returns>
public string GetText(string textPath)
{

XmlNode node;
node = m_Doc.SelectSingleNode(textPath) ;
if (node == null) return textPath;
return node.InnerText;

}
#endregion
#region protected Methods
/// <summary>

/// Loads the Text of the Control and its
subcontrols from the language
/// table and changes them.
/// </summary>
/// <param name=“ctrl”>Control to be changed</param>
protected void HandleControlLanguage(Control ctrl)
{

if (ctrl == null)

return;

XmlNode node;
try
{

If (ctrl.Text.StartsWith (“§§”) )
{

node = m_Doc.SelectSingleNode(ctrl.Text.Remove(0, 2) ) ;

ctrl.Text = node.InnerText ;

}

}
catch{ }
InitializeControl(ctrl.ContextMenu) ;

foreach (Control c in ctrl.Controls)
{

HandleControlLanguage(c) ;

}

}
/// <summary>

/// Loads the Text of the menu from the language
table and changes them.
/// </summary>
/// <param name=“ctrl”>Control to be changed</param>
protected void HandleMenuLanguage(MenuItem mnuItem)
{

if (mnuItem == null)

return;

XmlNode node;
try
{

if (mnuItem.Text.StartsWith(“§§”) )
{

node =

m_Doc.SelectSingleNode(mnuItem.Text.Remove(0, 2) ) ;

mnuItem.Text = node.InnerText:

}

}
catch{ }
foreach (MenuItem mi in mnuItem.MenuItems)
{

HandleMenuLanguage (mi) ;

}

{
#endregion
}

}

1-12. (canceled)

13. A method of configuring a language of a computer program, the method which comprises the following steps:
selecting a text memory wherein alphanumeric message character strings are associated with alphanumeric identification expressions;
finding in the text memory identification expressions associated with wildcard character strings contained in the computer program and replacing the wildcard character strings in the computer program with the associated message character strings in the text memory, and thereby:
carrying out the finding and replacing steps during a runtime of an executable binary computer program; and
carrying out the replacing step by associating the message character strings with memory variables in the running computer programs.

14. The method according to claim 13, which comprises selecting the text memory such that the identification expressions contain alphanumeric name descriptors and alphanumeric field descriptors, and a respective field descriptor has an associated message character string.

15. The method according to claim 14, wherein an identification expression in the text memory is found for a wildcard character string contained in a computer program by evaluating a path for the wildcard character string, and wherein the path is formed from at least one of the name descriptors.

16. The method according to claim 13, which comprising selecting the XML format for configuring the text memory, and finding the identification expressions by interpreting XML tags.

17. The method according to claim 16, which comprises storing identification expressions and message texts in an XML table in the XML text memory.

18. The method according to claim 13, which comprises reading the respective wildcard expressions to be replaced from a memory variable in a dialog structure in the computer program.

19. A method of configuring a language of a computer program, the method which comprises the following steps:
selecting a text memory wherein alphanumeric message character strings are associated with alphanumeric identification expressions;
running the computer program by runtime execution of an executable binary program file and, during the execution:
finding in the text memory identification expressions associated with wildcard character strings contained in the computer program and replacing the wildcard character strings in the computer program with the associated message character strings in the text memory, by assigning the message character strings to memory variables in the running computer programs.

20. A computer system with means for configuring the language of a computer program stored in the computer system, comprising:
a text memory having stored therein an association between alphanumeric identification expressions and alphanumeric message character strings;
means for finding identification expressions in said text memory associated with wildcard character strings contained in the computer program and for replacing the wildcard character strings in the computer program with the associated message character strings in said text memory; and
wherein the computer program is in executable binary code and said means for finding and replacing are contained in the computer program.

21. The computer system according to claim 20, wherein the identification expressions contained in said text memory contain at least one alphanumeric name descriptor and at least one alphanumeric field descriptor, and a respective field descriptor has an associated message character string.

22. The computer system according to claim 21, wherein the wildcard character strings contained in the computer program have a respective path formed from at least one of said name descriptors.

23. The computer system according to claim 20, wherein said text memory is in XML format, and wherein name descriptors are shown as XML tag names and field descriptors are shown as XML attribute names.

24. The computer system according to claim 20, wherein a respective wildcard character string contains at least one XML tag name, and the wildcard character string starts with a characteristic prefix.

25. The computer system according to claim 20, wherein the wildcard character strings to be replaced are stored in a memory variable in a dialog structure in the computer program.
